(19) United States
(12) Patent Application Publication
(10) Pub. No.: US 2024/0290228 A1
(43) Pub. Date: Aug. 29, 2024

(54) SUPPORT COMPOSITE PLATE, MANUFACTURING METHOD THEREOF, AND DISPLAY MODULE

(71) Applicants: Wuhan China Star Optoelectronics Technology Co., Ltd., Wuhan, Hubei (CN); Wuhan China Star Optoelectronics Semiconductor Display Technology Co., Ltd., Wuhan, Hubei (CN)

(72) Inventors: Defu ZHU, Wuhan, Hubei (CN); Yingbao HUANG, Wuhan, Hubei (CN)

(73) Assignees: Wuhan China Star Optoelectronics Technology Co., Ltd., Wuhan, Hubei (CN); Wuhan China Star Optoelectronics Semiconductor Display Technology Co., Ltd., Wuhan, Hubei (CN)

(21) Appl. No.: 17/293,050

(22) PCT Filed: Apr. 16, 2021
(86) PCT No.: PCT/CN2021/087644

§ 371 Date: May 16, 2024

(30) Foreign Application Priority Data
Apr. 1, 2021 (CN) 202110356239.2

(51) Int. Cl. G09F 9/30; G06F 1/16

(52) U.S. Cl. CPC G09F 9/301; G06F 1/1641

(57) ABSTRACT

A support composite plate, a manufacturing method thereof, and a display module are provided. The support composite plate includes at least one bending area and non-bending areas positioned on both sides of the bending area, and includes a support layer, a buffer layer, and a hardened layer. Wherein, the support layer is defined with at least one opening corresponding to the bending area, the buffer layer is disposed in the bending area and fills the opening, the hardened layer is disposed on the buffer layer, and the buffer layer overlaps at least a part of the support layer.

### FIELD OF INVENTION

The present disclosure relates to the field of display technologies, and more particularly, to a support composite plate, a manufacturing method thereof, and a display module.

### BACKGROUND OF INVENTION

With development of technologies, appearances of mobile electronic devices have changed drastically, and flexible screens have attracted much attention for their unique characteristics and huge potentials, especially bendable smart devices.

In current dynamic foldable module screens (DF module screens), support layers of display screens usually adopt stainless-steel material. The stainless-steel material is mainly configured to: 1. improve stiffness of screens in non-bending areas and prevent severe poor appearances during processes such as bending; 2. ensure a number of bending of the screens due to its good bending characteristics. However, using stainless steel as the support layers has higher requirements for material purity, and it also has technical problems of having a great stress when bending and being prone to develop cracks.

Therefore, it is necessary to provide a support composite plate to solve the technical problems above.

### SUMMARY OF INVENTION

### Technical Problem

Technical problem: in current dynamic foldable module screens, using stainless steel as the support layers has higher requirements for material purity, and it also has the technical problems of having the great stress when bending and being prone to develop cracks.

### Solution to Technical Problem

### Technical Solution

An embodiment of the present disclosure provides a support composite plate, a manufacturing method thereof, and a display module, which can prevent a support layer from cracking due to bending the support composite plate.

To realize above objective, an embodiment of the present disclosure provides technical solutions as follows.

An embodiment of the present disclosure provides the support composite plate, which includes at least one bending area and non-bending areas positioned on both sides of the bending area and includes the support layer, a buffer layer, and a hardened layer.

Wherein, the support layer is defined with at least one opening corresponding to the bending area, the buffer layer is disposed in the bending area and fills the opening, the hardened layer is disposed on the buffer layer, and the buffer layer overlaps at least a part of the support layer.

In the support composite plate provided by the embodiments of the present disclosure, edges of two ends of the buffer layer are flush with edges of two ends of the support layer.

In the support composite plate provided by the embodiments of the present disclosure, the support composite plate includes a first bending area and a second bending area;
wherein, a first opening and a second opening are defined on the support layer, the first bending area corresponds to the first opening, the second bending area corresponds to the second opening, and a cross-sectional shape of the first opening is different from a cross-sectional shape of the second opening.

In the support composite plate provided by the embodiments of the present disclosure, the support layer includes at least one protrusion extending toward the opening and disposed in the bending area.

In the support composite plate provided by the embodiments of the present disclosure, the support composite plate further includes an adhesive layer disposed on one side of the hardened layer away from the support layer.

In the support composite plate provided by the embodiments of the present disclosure, the buffer layer includes a rubber material, and a thickness of the buffer layer ranges from 50 um to 100 um; the support layer includes a metal material, and a thickness of the support layer ranges from 30 um to 50 um; and the hardened layer includes a polymethylmethacrylate-based polymer material and a silicon-based polymer material, and a thickness of the hardened layer ranges from 5 um to 20 um.

In the support composite plate provided by the embodiments of the present disclosure, the rubber material includes black fillers and light-absorbing particles.

Correspondingly, an embodiment of the present disclosure further provides a manufacturing method of a support composite plate, which includes following steps:
providing a support layer defined with an opening;
forming a buffer layer on the support layer, wherein the buffer layer fills the opening and overlaps at least a part of the support layer;
forming a hardened layer on the buffer layer; and
forming an adhesive layer on one side of the hardened layer away from the support layer.

In the manufacturing method of the support composite plate provided by the embodiments of the present disclosure, edges of two ends of the buffer layer are flush with edges of two ends of the support layer.

In the manufacturing method of the support composite plate provided by the embodiments of the present disclosure, the support composite plate includes a first bending area and a second bending area;
wherein, a first opening and a second opening are defined on the support layer, the first bending area corresponds to the first opening, the second bending area corresponds to the second opening, and a cross-sectional shape of the first opening is different from a cross-sectional shape of the second opening.

In the manufacturing method of the support composite plate provided by the embodiments of the present disclosure, the support layer includes at least one protrusion extending toward the opening and disposed in the bending area.

In the manufacturing method of the support composite plate provided by the embodiments of the present disclosure, the support composite plate further includes an adhesive layer disposed on one side of the hardened layer away from the support layer.

In the manufacturing method of the support composite plate provided by the embodiments of the present disclosure, the buffer layer includes a rubber material, and a thickness of the buffer layer ranges from 50 um to 100 um; the support layer includes a metal material, and a thickness of the support layer ranges from 30 um to 50 um; and the hardened layer includes a polymethylmethacrylate-based polymer material and a silicon-based polymer material, and a thickness of the hardened layer ranges from 5 um to 20 um.

In the manufacturing method of the support composite plate provided by the embodiments of the present disclosure, the rubber material includes black fillers and light-absorbing particles.

In the manufacturing method of the support composite plate provided by the embodiments of the present disclosure, the buffer layer is composited with the support layer by a hot-pressing process or a laminating process.

Correspondingly, an embodiment of the present disclosure further provides a display module, which includes a support composite plate, a backplate disposed on the support composite plate, and a display panel disposed on the backplate;
wherein, the support layer is defined with at least one opening corresponding to the bending area, the buffer layer is disposed in the bending area and fills the opening, the hardened layer is disposed on the buffer layer, and the buffer layer overlaps at least a part of the support layer.

In the display module provided by the embodiments of the present disclosure, edges of two ends of the buffer layer are flush with edges of two ends of the support layer.

In the display module provided by the embodiments of the present disclosure, the support composite plate includes a first bending area and a second bending area; and
a first opening and a second opening are defined on the support layer, the first bending area corresponds to the first opening, the second bending area corresponds to the second opening, and a cross-sectional shape of the first opening is different from a cross-sectional shape of the second opening.

In the display module provided by the embodiments of the present disclosure, the support layer includes at least one protrusion extending toward the opening and disposed in the bending area.

In the display module provided by the embodiments of the present disclosure, the support composite plate further includes an adhesive layer disposed on one side of the hardened layer away from the support layer.

### BENEFICIAL EFFECTS OF INVENTION

### Beneficial Effects

Beneficial effect: compared to current technology, in the support composite plate, the manufacturing method thereof, and the display module provided by the embodiments of the present disclosure, the buffer layer in the support composite plate completely fills the opening of the support layer, and the rubber material is selected for a material of the buffer layer. Therefore, the present disclosure can effectively reduce laminating processes of the display module while improving bendability of the display panel, thereby further improving a yield of the display module and reducing cost.

### BRIEF DESCRIPTION TO DRAWINGS

### Description of Drawings

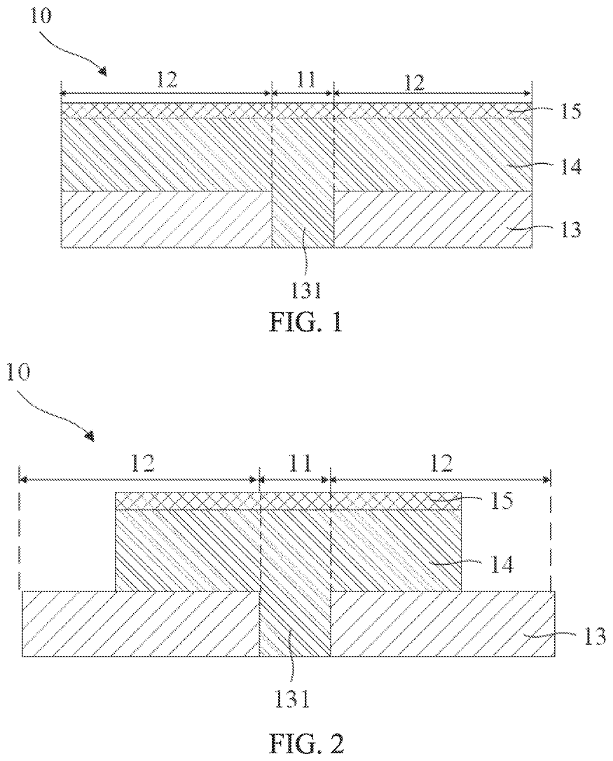

FIG. 1 is a schematic film layer structural diagram of a support composite plate according to embodiment 1 of the present disclosure.

FIG. 2 is a schematic film layer structural diagram of a support composite plate according to embodiment 2 of the present disclosure.

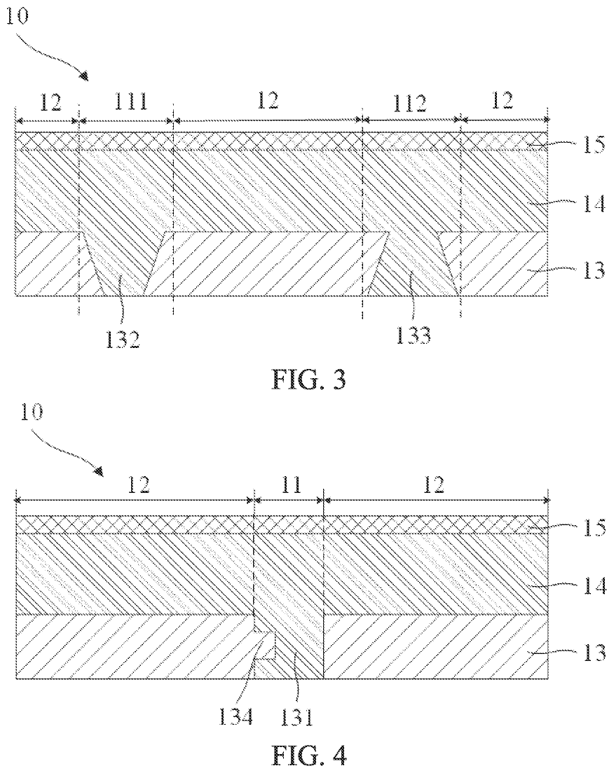

FIG. 3 is a schematic film layer structural diagram of a support composite plate according to embodiment 3 of the present disclosure.

FIG. 4 is a schematic film layer structural diagram of a support composite plate according to embodiment 4 of the present disclosure.

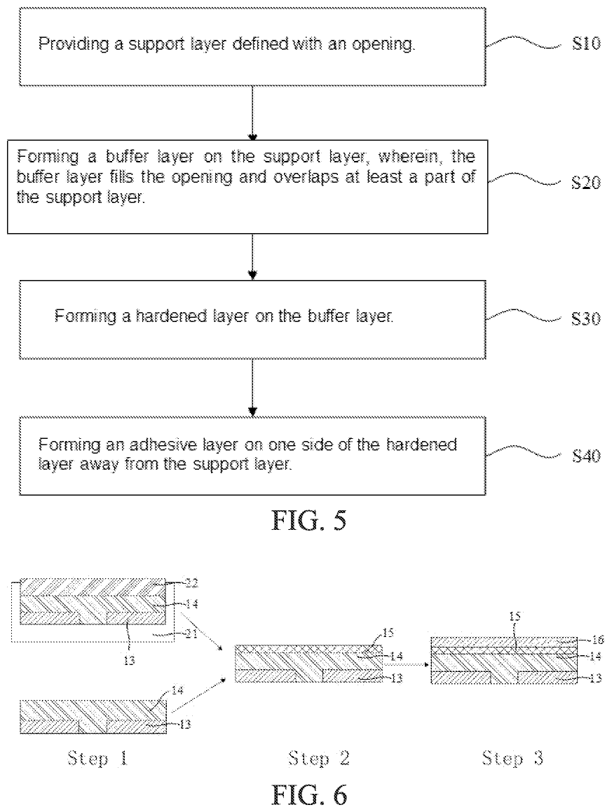

FIG. 5 is a flowchart of a manufacturing method of a support composite plate according to an embodiment of the present disclosure.

FIG. 6 is a schematic molding diagram of the support composite plate according to an embodiment of the present disclosure.

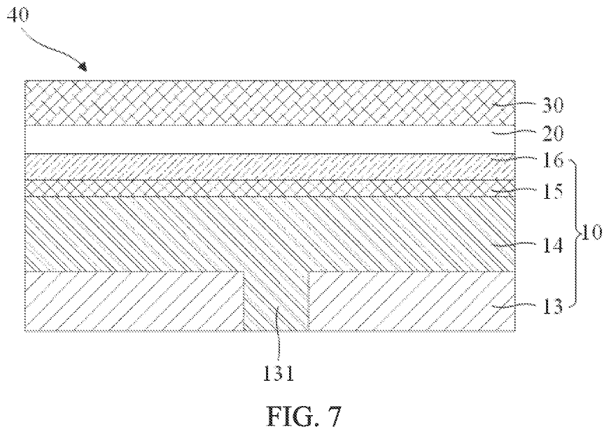

FIG. 7 is a schematic film layer structural diagram of a display module according to an embodiment of the present disclosure.

### EMBODIMENTS OF INVENTION

### Detailed Description of Preferred Embodiments

Existing support composite plates, manufacturing methods thereof, and display modules have technical problems of supports layers of the support composite plates being prone to develop cracks during bending and a part of patterned support layers in bending areas being prone to transfer to surfaces of screens and causing poor appearances of display panels. The embodiments of the present disclosure can solve the technical problems above.

Referring to FIGS. 1 to 4, an embodiment of the present disclosure provides a support composite plate 10, which includes at least one bending area 11 and non-bending areas 12 positioned on both sides of the bending area 11, and further includes a support layer 13, a buffer layer 14, and a hardened layer 15.

In this embodiment, the support layer 13 is defined with at least one opening 131 corresponding to the bending area 11, the buffer layer 14 is disposed in the bending area 11 and fills the opening 131, the hardened layer 15 is disposed on the buffer layer 14, and the buffer layer 14 overlaps at least a part of the support layer 13.

In the support composite plate 10 provided by the embodiment of the present disclosure, the buffer layer 14 in the support composite plate 10 completely fills the opening 131 of the support layer 13, and a rubber material is selected for a material of the buffer layer 14. Therefore, the present disclosure can effectively reduce laminating processes of a display module 40 while improving bendability of the display module 40, thereby further improving a yield of the display module 40 and reducing cost.

Specific embodiments are used to describe technical solutions of the present disclosure.

### Embodiment 1

As shown in FIG. 1, the support composite plate 10 provided by embodiment 1 of the present disclosure includes the at least one bending area 11 and the non-bending areas 12 positioned on both sides of the bending area 11, and further includes the support layer 13, the buffer layer 14, and the hardened layer 15. The support layer 13 is defined with the at least one opening 131 corresponding to the bending area 11, the buffer layer 14 is disposed in the bending area 11 and fills the opening 131, the hardened layer 15 is disposed on the buffer layer 14, and edges of two ends of the buffer layer 14 are flush with edges of two ends of the support layer 13.

In this embodiment, a material of the support layer 13 may be a metal material, and specifically, may include copper or stainless steel (SUS). The support layer 13 includes the opening 131 and mainly plays a role of support and bending. The opening 131 is mainly configured to reduce stresses generated when the support layer 13 is bent. A thickness of a part of the support layer 13 at both ends of the opening 131 ranges from 30 um to 150 um, and specifically is 100 um.

For the existing support composite plates, using stainless steel as support layers has higher requirements for material purity, and it also has technical problems of having a great stress when bending and being prone to develop cracks. By making the edges of two ends of the buffer layer 14 be flush with the edges of two ends of the support layer 13 in the support composite plate 10, allowing the buffer layer 14 to completely fill the opening 131 of the support layer 13, and selecting a rubber material as a material of the buffer layer 14, embodiment 1 of the present disclosure can improve bendability of the support composite plate 10.

### Embodiment 2

As shown in FIG. 2, the support composite plate 10 provided by embodiment 2 of the present disclosure includes the at least one bending area 11 and the non-bending areas 12 positioned on both sides of the bending area 11, and further includes the support layer 13, the buffer layer 14, and the hardened layer 15. The support layer 13 is defined with the at least one opening 131 corresponding to the bending area 11, the buffer layer 14 is disposed in the bending area 11 and fills the opening 131, the hardened layer 15 is disposed on the buffer layer 14, and the buffer layer 14 overlaps a part of the support layer 13.

In this embodiment, the material of the support layer 13 may be the metal material, and specifically, may include copper or stainless steel (SUS). The support layer 13 includes the opening 131 and mainly plays a role of support and bending. The opening 131 is mainly configured to reduce stresses generated when the support layer 13 is bent. Further, the thickness of the part of the support layer 13 at both ends of the opening 131 ranges from 30 um to 150 um, and specifically is 120 um.

For the existing support composite plates, using stainless steel as the support layers has higher requirements for material purity, and it also has the technical problems of having the great stress when bending and being prone to develop cracks. By making the buffer layer 14 overlap the part of the support layer 13 in the support composite plate 10, allowing the buffer layer 14 to completely fill the opening 131 of the support layer 13, and selecting the rubber material as the material of the buffer layer 14, embodiment 2 of the present disclosure can improve the bendability of the support composite plate 10.

### Embodiment 3

As shown in FIG. 3, the support composite plate 10 provided by embodiment 3 of the present disclosure includes a first bending area 111 and a second bending area 112 disposed at intervals, and includes the non-bending areas 12 positioned outside the first bending area 111 and the second bending area 112. The support composite plate 10 further includes the support layer 13, the buffer layer 14, and the hardened layer 15. A first opening 132 and a second opening 133 are defined on the support layer 13, the first bending area 111 corresponds to the first opening 132, the second bending area 112 corresponds to the second opening 133, and a cross-sectional shape of the first opening 132 is different from a cross-sectional shape of the second opening 133. The buffer layer 14 is disposed in the bending areas (111, 112) and fills the openings (132, 133), and the hardened layer 15 is disposed on the buffer layer 14.

Wherein, the edges of two ends of the buffer layer 14 are flush with the edges of two ends of the support layer 13.

Optionally, in some embodiments of the present disclosure, the material of the support layer 13 may be the metal material, and specifically, may include copper or stainless steel (SUS). The support layer 13 includes the first opening 132 and the second opening 133, and mainly plays a role of support and bending. The first opening 132 is mainly configured to reduce stresses generated when the support layer 13 is bent along a first direction, the second opening 133 is mainly configured to reduce stresses generated when the support layer 13 is bent along a second direction, and the first direction and the second direction are opposite to each other. Wherein, a thickness of a part of the support layer 13 positioned in the non-bending areas 12 ranges from 30 um to 150 um, and specifically is 130 um.

For the existing support composite plates, using stainless steel as the support layers has higher requirements for material purity, and it also has the technical problems of having the great stress when bending and being prone to develop cracks. By making the buffer layer 14 overlap whole the support layer 13 in the support composite plate 10, allowing the buffer layer 14 to completely fill the first opening 132 and the second opening 133 of the support layer 13, and selecting the rubber material as the material of the buffer layer 14, embodiment 3 of the present disclosure can improve the bendability of the support composite plate 10.

### Embodiment 4

As shown in FIG. 4, the support composite plate 10 provided by embodiment 4 of the present disclosure includes the at least one bending area 11 and the non-bending areas 12 positioned on both sides of the bending area 11, and further includes the support layer 13, the buffer layer 14, and the hardened layer 15. The support layer 13 is defined with the at least one opening 131 corresponding to the bending area 11, the buffer layer 14 is disposed in the bending area 11 and fills the opening 131, and the hardened layer 15 is disposed on the buffer layer 14.

Wherein, the edges of two ends of the buffer layer 14 are flush with the edges of two ends of the support layer 13, and the support layer 13 includes at least one protrusion 134 extending toward the opening 131 and disposed in the bending area 11.

In this embodiment, the material of the support layer 13 may be the metal material, and specifically, may include copper or stainless steel (SUS). The support layer 13 includes the opening 131 and mainly plays a role of support and bending. The opening 131 is mainly configured to reduce the stresses generated when the support layer 13 is bent. In this embodiment, the support layer 13 includes the at least one protrusion 134 extending toward the opening 131 and disposed in the bending area 11, and the protrusion 134 is mainly configured to reduce the stresses generated when the support layer 13 is bent. The thickness of the part of the support layer 13 at both ends of the opening 131 ranges from 30 um to 150 um, and specifically is 90 um.

For the existing support composite plates, using stainless steel as the support layers has higher requirements for material purity, and it also has the technical problems of having the great stress when bending and being prone to develop cracks. By allowing the buffer layer 14 in the support composite plate 10 to completely fill the opening 131 of the support layer 13, selecting the rubber material as the material of the buffer layer 14, and adding the protrusion 134 in the opening 131 at a same time, embodiment 4 of the present disclosure can further improve the bendability of the support composite plate 10.

In this embodiment, the support layer 13 may include a first protrusion and a second protrusion extending toward the opening 131, and the first protrusion and the second protrusion are disposed opposite to each other and are positioned on different horizontal planes. By disposing the first protrusion and the second protrusion in the support layer 13, a contact area between the support layer 13 and the buffer layer 14 in the bending area 11 can be increased, thereby further improving the bendability of the support composite plate 10.

In this embodiment, the support layer 13 may also include at least one groove extending toward the opening 131. By defining the groove in the bending area of the support layer 13, a volume of the buffer layer 14 in the bending area 11 can be increased, thereby further improving the bendability of the support composite plate 10.

In the embodiments of the present disclosure above, the material of the buffer layer includes the rubber material, and a thickness of the buffer layer 14 ranges from 50 um to 100 um, and specifically is 80 um. Wherein, if the thickness of the buffer layer 14 is less than 50 um, the buffer layer 14 cannot achieve a good buffering effect, and if the thickness of the buffer layer 14 is greater than 100 um, the support composite plate 10 cannot effectively play its original supporting role.

The rubber material includes black fillers and light-absorbing particles, so that reflection of ambient light can be reduced, thereby being beneficial to improve a taste of appearance of screens in a dark state.

In the embodiments of the present disclosure above, the rubber material is polyurethane.

Since the rubber material has good flexibility and buffering performance, the buffer layer 14 can play a buffering role. Meanwhile, filling the opening of the support layer 13 with the rubber material can prevent an imprint problem caused by patterning of the support layer 13 in an opening area and a crack problem caused by bending the support layer 13. Meanwhile, the part of the support layer 13 in the non-bending areas are retained to play an original supporting role.

In the embodiments of the present disclosure above, using a black rubber material to replace a foam material used in current technology not only can play a buffering role of foam, but also can improve an appearance problem such as orange peel patterns caused by nonuniform surfaces of foam.

In the embodiments of the present disclosure above, a material of the hardened layer 15 includes a polymethylmethacrylate-based polymer material and a silicon-based polymer material, and a thickness of the hardened layer 15 ranges from 5 um to 20 um.

In the embodiments of the present disclosure above, a process of manufacturing the hardened layer 15 is as follows.

Firstly, preparing a liquid as a hard coating slurry. The hard coating slurry is a chemical composite of polymer raw materials. The hard coating slurry forms the hardened layer 15 and is synthesized by inorganic and organic mixtures. For example, the hard coating slurry may be synthesized by a polymethylmethacrylate-based polymer (PMMA-based polymer) and a silicon-based polymer. It should be understood that inorganics and organics of the hard coating slurry may consist of other materials. The silicon-based polymer may include ethylene oxide and silsesquioxane. A material replacing PMMA may also be a monomer or oligomer having at least one functional group such as epoxy group, acrylate group, and polyurethane acrylate group. Firstly, the hard coating slurry having a mass concentration ranging from 20% to 30% is prepared, coating the hard coating slurry on a surface of the buffer layer 14 away from the support layer 13, and baking a hard coating slurry film formed on the buffer layer 14 in an oven to obtain the hardened layer 15.

Wherein, if the mass concentration of the hard coating slurry is less than 20%, a stiffness of the hardened layer 15 obtained is too low to resist stresses caused by thermal expansion and contraction of the rubber material, and if the mass concentration of the hard coating slurry is greater than 30% and causes an amount of solvent needed to be too low, it is difficult for the hardened layer 15 obtained to completely be deposited on the buffer layer 14.

By coating the hardened layer 15 on the surface of the buffer layer 14, the embodiments above not only can level uneven surfaces of the buffer layer 14 adopting the rubber material during coating, thereby improving flatness of the buffer layer 14, but also can resist stresses caused by thermal expansion and contraction of the rubber material after curing, thereby preventing a backplate of a display panel from directly undergoing the stresses and causing the display panel to undergo an overly large force.

In this embodiment, the thickness of the hardened layer 15 ranges from 3 um to 20 um, and specifically is 10 um.

In the embodiments of the present disclosure above, the support composite plate 10 provided by the embodiments further includes an adhesive layer disposed on the hardened layer 15, and the adhesive layer is configured to attach the hardened layer 15 to the backplate of the display panel. Further, the adhesive layer is a pressure sensitive adhesive (PSA) or an optically clear adhesive (OCA).

Referring to FIG. 5, FIG. 5 is a flowchart of a manufacturing method of the support composite plate according to an embodiment of the present disclosure. The method includes following steps.
S10: providing the support layer defined with the opening;
S20: forming the buffer layer on the support layer, wherein, the buffer layer fills the opening and overlaps at least a part of the support layer;
S30: forming the hardened layer on the buffer layer; and
S40: forming the adhesive layer on one side of the hardened layer away from the support layer.

Referring to FIG. 6, FIG. 6 is a schematic molding diagram of the support composite plate according to an embodiment of the present disclosure. Specifically, steps of molding the support composite plate are as follows.

Step 1: firstly, etching the metal material for preparing the support layer 13 to a suitable size and defining the opening, then attaching the support layer 13 to both ends of a concave mold 21, hot pressing to allow the metal material of the support layer 13 to be composited with the rubber material for preparing the buffer layer 14 by another concave mold 22, and filling the opening of the support layer 13 with the rubber material.

Or, the rubber material for preparing the buffer layer 14 may be pressed to form a convex structure firstly, and the support layer 13 defined with the opening is attached to both ends of a bump of the buffer layer 14.

In the step S10, the opening is formed by patterning the support layer 13 in the bending area.

Optionally, in some embodiments of the present disclosure, the support composite plate 10 includes the first bending area and the second bending area, the first opening and the second opening are defined on the support layer 13, the first bending area corresponds to the first opening, the second bending area corresponds to the second opening, and the cross-sectional shape of the first opening is different from the cross-sectional shape of the second opening.

Optionally, in some embodiments of the present disclosure, the buffer layer 14 overlaps the support layer 13, and the edges of two ends of the buffer layer 14 are flush with the edges of two ends of the support layer 13.

Optionally, in some embodiments of the present disclosure, the buffer layer 14 overlaps a part of the support layer 13.

Optionally, in some embodiments of the present disclosure, the support layer 13 includes the at least one protrusion extending toward the opening and disposed in the bending area, and the protrusion is formed by patterning the support layer 13.

Step 2: firstly, preparing the hard coating slurry having the mass concentration ranging from 20% to 30%, coating the hard coating slurry on the surface of the buffer layer 14 away from the support layer 13, and baking the hard coating slurry film formed on the buffer layer 14 in the oven to obtain the hardened layer 15. Wherein, the material of the hardened layer 15 includes the polymethylmethacrylate-based polymer material and the silicon-based polymer material, and the thickness of the hardened layer 15 ranges from 5 um to 20 um.

Step 3: coating PSA or OCA on a surface of the hardened layer 15 to form the adhesive layer 16.

Applying the support composite plate manufactured by the method above to the display module can effectively reduce laminating processes of the display module, thereby being beneficial to improve overall yield and reducing the cost.

Correspondingly, the present disclosure further provides the display module 40. As shown in FIG. 7, FIG. 7 is a schematic film layer structural diagram of the display module 40 according to an embodiment of the present disclosure.

Wherein, the display module includes the support composite plate 10 mentioned above, the backplate 20 disposed on the support composite plate 10, and the display panel 30 disposed on the backplate 20, and one side of the support composite plate 10 provided with the hardened layer 15 is attached to the backplate 20 with the adhesive layer 16.

The embodiments of the present disclosure provide the support composite plate, the manufacturing method thereof, and the display module. The support composite plate includes the at least one bending area and the non-bending areas positioned on both sides of the bending area, and includes the support layer, the buffer layer, and the hardened layer. Wherein, the support layer is defined with the at least one opening corresponding to the bending area, the buffer layer is disposed in the bending area and fills the opening, the hardened layer is disposed on the buffer layer, and the buffer layer overlaps at least a part of the support layer. The present disclosure can effectively reduce laminating processes of the display module while improving the bendability of the display panel, thereby further improving the yield of the display module and reducing the cost.

The specific implementation of the above operations can be referred to the previous embodiments, and will not be repeated here.

In summary, the embodiments of the present disclosure provide the support composite plate, the manufacturing method thereof, and the display module. The support composite plate includes the at least one bending area and the non-bending areas positioned on both sides of the bending area, and includes the support layer, the buffer layer, and the hardened layer. Wherein, the support layer is defined with the at least one opening corresponding to the bending area, the buffer layer is disposed in the bending area and fills the opening, the hardened layer is disposed on the buffer layer, and the buffer layer overlaps at least a part of the support layer. The present disclosure can effectively reduce laminating processes of the display module while improving the bendability of the display panel, thereby further improving the yield of the display module and reducing the cost.

It can be understood that for a person of ordinary skill in the art, equivalent replacements or changes can be made according to the technical solution of the present disclosure and its inventive concept, and all these changes or replacements should fall within the protection scope of the claims attached to the present disclosure.

1. A support composite plate, comprising at least one bending area and non-bending areas positioned on both sides of the bending area, and wherein the support composite plate further comprises:
a support layer, wherein at least one opening is defined on the support layer and corresponds to the bending area;
a buffer layer disposed in the bending area and filling the opening; and
a hardened layer disposed on the buffer layer;
wherein the buffer layer overlaps at least a part of the support layer.

2. The support composite plate according to claim 1, wherein edges of two ends of the buffer layer are flush with edges of two ends of the support layer.

3. The support composite plate according to claim 1, comprising a first bending area and a second bending area;
wherein a first opening and a second opening are defined on the support layer, the first bending area corresponds to the first opening, the second bending area corresponds to the second opening, and a cross-sectional shape of the first opening is different from a cross-sectional shape of the second opening.

4. The support composite plate according to claim 1, wherein the support layer comprises at least one protrusion extending toward the opening and disposed in the bending area.

5. The support composite plate according to claim 1, further comprising an adhesive layer disposed on one side of the hardened layer away from the support layer.

6. The support composite plate according to claim 1, wherein the buffer layer comprises a rubber material, and a thickness of the buffer layer ranges from 50 um to 100 um;
the support layer comprises a metal material, and a thickness of the support layer ranges from 30 um to 50 um; and
the hardened layer comprises a polymethylmethacrylate-based polymer material and a silicon-based polymer material, and a thickness of the hardened layer ranges from 5 um to 20 um.

7. The support composite plate according to claim 6, wherein the rubber material comprises black fillers and light-absorbing particles.

8. A manufacturing method of a support composite plate, wherein the support composite plate comprises at least one bending area and non-bending areas positioned on both sides of the bending area, the method comprises following steps:
providing a support layer defined with at least one opening;
forming a buffer layer on the support layer, wherein the buffer layer fills the opening and overlaps at least a part of the support layer; and
forming a hardened layer on the buffer layer.

9. The manufacturing method of the support composite plate according to claim 8, wherein edges of two ends of the buffer layer are flush with edges of two ends of the support layer.

10. The manufacturing method of the support composite plate according to claim 8, wherein the support composite plate comprises a first bending area and a second bending area; and
a first opening and a second opening are defined on the support layer, the first bending area corresponds to the first opening, the second bending area corresponds to the second opening, and a cross-sectional shape of the first opening is different from a cross-sectional shape of the second opening.

11. The manufacturing method of the support composite plate according to claim 8, wherein the support layer comprises at least one protrusion extending toward the opening and disposed in the bending area.

12. The manufacturing method of the support composite plate according to claim 8, further comprising a following step:
forming an adhesive layer on one side of the hardened layer away from the support layer.

13. The manufacturing method of the support composite plate according to claim 8, wherein the buffer layer comprises a rubber material, and a thickness of the buffer layer ranges from 50 um to 100 um;
the support layer comprises a metal material, and a thickness of the support layer ranges from 30 um to 50 um; and
the hardened layer comprises a polymethylmethacrylate-based polymer material and a silicon-based polymer material, and a thickness of the hardened layer ranges from 5 um to 20 um.

14. The manufacturing method of the support composite plate according to claim 13, wherein the rubber material comprises black fillers and light-absorbing particles.

15. The manufacturing method of the support composite plate according to claim 8, wherein the buffer layer is composited with the support layer by a hot-pressing process or a laminating process.

16. A display module, comprising a support composite plate, a backplate disposed on the support composite plate, and a display panel disposed on the backplate;
wherein the support composite plate comprises at least one bending area and non-bending areas positioned on both sides of the bending area, and the support composite plate further comprises:
a support layer, wherein at least one opening is defined on the support layer and corresponds to the bending area;
a buffer layer disposed in the bending area and filling the opening; and
a hardened layer disposed on the buffer layer;
wherein the buffer layer overlaps at least a part of the support layer.

17. The display module according to claim 16, wherein edges of two ends of the buffer layer are flush with edges of two ends of the support layer.

18. The display module according to claim 16, wherein the support composite plate comprises a first bending area and a second bending area; and
a first opening and a second opening are defined on the support layer, the first bending area corresponds to the first opening, the second bending area corresponds to the second opening, and a cross-sectional shape of the first opening is different from a cross-sectional shape of the second opening.

19. The display module according to claim 16, wherein the support layer comprises at least one protrusion extending toward the opening and disposed in the bending area.

20. The display module according to claim 16, wherein the support composite plate further comprises an adhesive layer disposed on one side of the hardened layer away from the support layer.
